(19) United States
(12) Patent Application Publication
(10) Pub. No.: US 2005/0237934 A1
(43) Pub. Date: Oct. 27, 2005

(54) Information distribution system

(75) Inventors: Kenji Mito, Tsurugashima-shi (JP); Toshiaki Tsuchiya, Tsurugashima-shi (JP); Kiyoshi Yajima, Tsurugashima-shi (JP); Tomoyuki Fujieda, Tsurugashima-shi (JP); Kazuyoshi Takahashi, Tsurugashima-shi (JP)

Correspondence Address: MORGAN LEWIS & BOCKIUS LLP, 1111 PENNSYLVANIA AVENUE NW, WASHINGTON, DC, 20004, US

(73) Assignee: PIONEER CORPORATION

(21) Appl. No.: 11/108,056

(22) Filed: Apr. 18, 2005

(30) Foreign Application Priority Data
Apr. 19, 2004 (JP) 2004-122697

(51) Int. Cl. H04J 1/16

(52) U.S. Cl. 370/232

(57) ABSTRACT

Disclosed is an information distribution system capable of distributing high quality data without lowering throughput of a network even in a communication area where many movable bodies could be traveling. The information distribution system comprises a radio transmission unit for transmitting data signals at a transmission rate being variable; a detection unit for detecting speed control information for a mobile object having a receiver for receiving data signals transmitted without wires from the radio transmission unit; and a transmission rate setting unit for changing the transmission rate of the data signals according to the speed control information.

### BACKGROUND OF THE INVENTION

1. Field of the Invention

The present invention relates to an information distribution system for distributing information through a radio transmission channel, and to related technology thereof.

2. Description of the Related Art

As a system for distributing information to a mobile object or movable body, such as a vehicle, via a radio transmission line, VICS (Vehicle Information and Communication System), which distributes traffic information including road conditions to the vehicle of a user using radio beacons, light beacons or FM multiple broadcasting, is known. Also along with the spread of cellular phones, the Internet and wireless LAN (Local Area Network), systems for distributing information to many unspecified movable bodies in a relatively narrow communication area using a wireless LAN conforming to IEEE 802.11 (Institute of Electrical and Electronics Engineers standard 802.11) have been proposed. This type of system is disclosed in Japanese Patent Kokai No. 2003-317187 and Japanese Patent Kokai No. 2001-184595.

Compared with an unmoving receive terminal, the quality of distribution information received by a receive terminal when moving generally tends to deteriorate more easily, and particularly when a transmission terminal distributes data to a moving receive terminal at a high transmission rate, the probability of the occurrence of receive errors is high. So in an auto fall back system, the receive terminal replies with an ACK (Acknowledgment) signal when receiving data from the transmission terminal succeeds. The transmission terminal transmits data at a relatively high transmission rate when ACK signals are being received from the receive terminal, and retransmits data at a low transmission rate if the ACK signal is not received after a predetermined time elapses so as to assure the reliability of information distribution.

Broadcasting data is appropriate to distribute data to many unspecified receive terminals. However if an ACK signal is demanded for all the receive terminals to assure the reliability of the broadcast communication, the throughput of the network tends to drop because of the increase in the retry count. If an ACK signal is not demanded for the receive terminals, however, the transmission terminal cannot resend the data at a low transmission rate appropriate for the transmission line, even if a receive error occurs, so the reliability of the information distribution cannot be completely assured. This problem in particular tends to occur when broadcast communication is performed in a communication area where many receive terminals are moving. This is also true for the case when data is multicasted to a plurality of receive terminals, that is when the same data is transmitted specifying the addresses of a plurality of receive terminals.

### SUMMARY OF THE INVENTION

In view of the foregoing, it is an object of the present invention to provide an information distribution system for enabling high quality data distribution without dropping the throughput of the network even in a communication area where a mobile object would be traveling.

According to one aspect of the present invention, an information distribution system is provided. This information distribution system comprises: a radio transmission unit for transmitting data signals at a transmission rate being variable; a detection unit for detecting speed control information for a mobile object having a receiver for receiving data signals transmitted without wires from the radio transmission unit; and a transmission rate setting unit for changing the transmission rate of the data signals according to the speed control information.

According to another aspect of the present invention, an information distribution system is provided. This information distribution system comprises: a radio transmission unit for transmitting data signals at a transmission rate being variable; a detection unit for detecting traffic congestion information for a mobile object having a receiver for receiving data signals transmitted without wires from the radio transmission unit; and a transmission rate setting unit for setting a transmission rate of the data signals according to the traffic congestion information.

Further features of the invention, its nature and various advantages will be more apparent from the accompanying drawings and the following detailed description of the preferred embodiments.

### BRIEF DESCRIPTION OF THE DRAWINGS

FIG. 1 is a block diagram depicting a general configuration of the information distribution system according to the first embodiment of the present invention;

FIG. 2 is a table showing the combination of the transmission rate, modulation method and encoding rate;

FIG. 3 is a diagram depicting a general structure of a frame signal according to the IEEE 802.11 standard;

FIG. 4A is a table showing the transmission rate according to the color of the traffic light, and FIG. 4B is a table showing the transmission rate according to the level of traffic congestion;

FIG. 5 is a flow chart depicting an example of the processing procedure by the controller of the data distribution device of the first embodiment;

FIG. 6 is a block diagram depicting a general configuration of the information distribution system according to a variant form of the first embodiment;

FIG. 7 is a block diagram depicting a general configuration of the information distribution system according to another variant form of the first embodiment;

FIG. 8 is a block diagram depicting a general configuration of the information distribution system according to the second embodiment of the present invention;

FIG. 9 is a timing chart to indicate the color of the traffic light;

FIG. 10 is a timing chart to indicate the color of the traffic light;

FIG. 11 is a flow chart depicting an example of the processing procedure by the controller of the data distribution device according to the second embodiment;

FIG. 12 is a flow chart depicting an example of the processing procedure by the controller of the data distribution device according to the second embodiment;

FIG. 13 is a block diagram depicting a general configuration of the information distribution system according to the third embodiment of the present invention;

FIG. 14 is a flow chart depicting an example of the processing procedure by the controller of the data distribution device according to the third embodiment;

FIG. 15 is a block diagram depicting a general configuration of the information distribution system according to the fourth embodiment of the present invention; and

FIG. 16 is a flow chart depicting an example of the processing procedure by the controller of the data distribution device according to the fourth embodiment.

### DETAILED DESCRIPTION OF THE INVENTION

Embodiments of the present invention will now be described with reference to the drawings.

### 1. First Embodiment

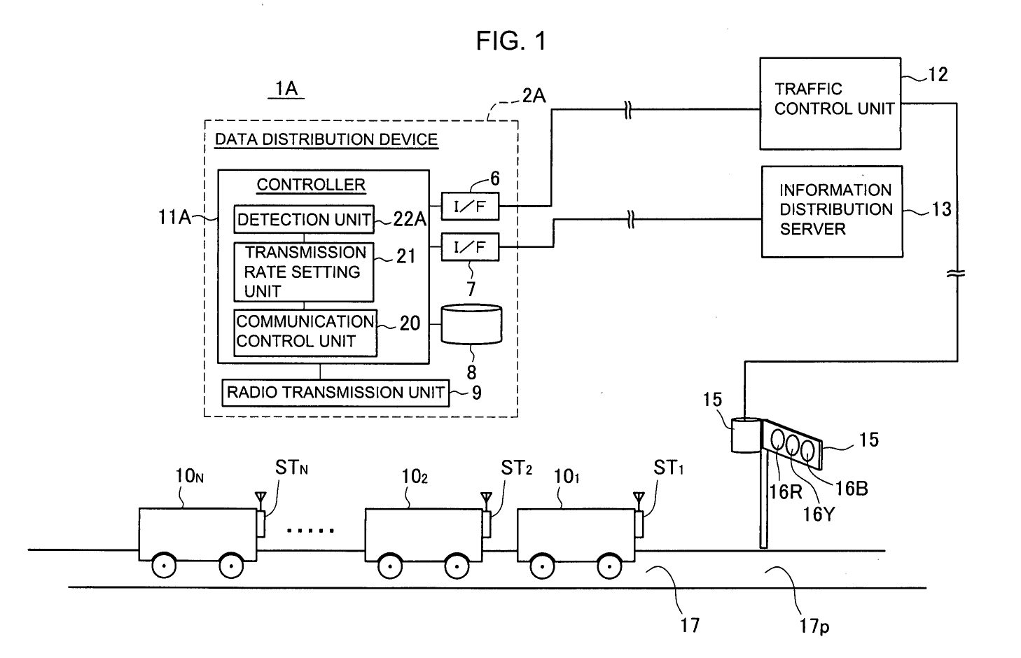

FIG. 1 is a block diagram depicting a general configuration of the information distribution system 1A according to the first embodiment of the present invention. The information distribution system 1A comprises a data distribution device 2A, a traffic control unit 12 and an information distribution server (information distribution source) 13. The data distribution device 2A further comprises a controller 11A, a radio transmission unit (access point) 9, communication interfaces (I/F) 6 and 7 and a distribution data storage unit 8, and the controller 11A further comprises a communication control unit 20, a transmission rate setting unit 21 and a detection unit 22A.

The controller 11A is an integrated circuit comprising a microprocessor, a non-volatile memory for storing programs, a RAM (Random Access Memory), an internal bus and an input/output interface. The communication control unit 20, the transmission rate setting unit 21 and the detection unit 22A may be constructed by a program or a series of instructions executed by the microprocessor, or may be built-in to the controller 11A as hardware.

The traffic control unit 12 generates the speed control information (or speed regulation information) according to a predetermined time schedule, supplies this to the traffic light 15, and remote-control the traffic light 15. The traffic light 15 has a control box 18, and the control box 18 controls the ON/OFF of the lights of the traffic light 15 based on the speed control information supplied by the traffic control unit 12. The controller 11A and the traffic control unit 12 are inter-connected via an electric communication line (not illustrated), such as a packet communication network. The traffic light 15 is positioned in the vicinity of the traveling path 17, and is traffic control means (or traffic regulation means) for controlling the speed of the movable bodies (vehicles) 10₁, 10₂, . . . , 10_{N} (N is an integer of 2 or higher) on the traveling path 17. The traffic light 15, which comprises a red light source 16R, a yellow light source 16Y and a blue light source 16B, turns ON or OFF the red light source 16R, yellow light source 16Y and blue light source 16B individually according to the speed control information provided by the traffic control unit 12. ON of the red light source 16R indicates “Stop”, ON of the yellow light source 16Y indicates “Go with caution”, and ON of the blue light source 16B indicates “Go”. The blue light source 16B may include an arrow shaped area which indicates “Go”. Or the blue light source 16B may have areas to indicate “Right turn possible” or “Left turn possible”, in addition to an area to indicate “Go”. For example, in some cases, an area to indicate “Right turn possible” of the blue light source 16B is turned ON, and an area to indicate “Go” is turned OFF at the same time with ON of the red light source 16R.

In the present embodiment, the traffic light for vehicles 15 is used, but the present invention is not limited to the traffic light for vehicles 15, and a traffic light or a bar for controlling the traveling speed of a pedestrian or a train, or a speaker which emits sound to control the traveling of the pedestrian may be used.

The movable bodies 10₁, . . . , 10_{N} have the receivers (stations) ST₁, . . . , ST_{N} respectively. The radio transmission unit 9 has a function to perform radio communication with the receivers ST₁, . . . , ST_{N}. The communication area is a relatively narrow area with a radius of several m-several hundred m. The radio communication standard to be used would be a known wireless LAN standard, such as IEEE 802.11 (Institute of Electrical and Electronics Engineers Standard 802.11), Bluetooth®, HIPERLAN/2 (HIgh PErformance Radio Local Area Network Type 2) or HiSWAN (High Speed Wireless Access System). IEEE 802.11 is a standard which includes IEEE 802.11a, IEEE 802.11b and IEEE 802.11g. For the communication medium, visible light, infrared (IR) or electro-magnetic waves on a radio frequency band can be used. In the present embodiment, the movable bodies are automobiles 10₁, . . . , 10_{N}, but the present invention is not limited to this, and a mobile object may be a train, a bicycle or a pedestrian.

The information distribution system 1A of the present embodiment distributes information to a plurality of movable bodies 10₁, 10₂, . . . , 10_{N}, but the information distribution system according to the present invention is not limited to a plurality of movable bodies but may distribute information to a single mobile object. This is the same for the later mentioned other embodiments.

The information distribution server 13 supplies distribution information, such as traffic information on an area around the control point (or regulation point) where the speed control of the movable bodies 10₁, . . . , 10_{N} is performed, that is an area around the location 17P where the traffic light 15 is positioned, and destination guide information, advertisement information or news information, to the controller 11A. The controller 11A and the information distribution server 13 are inter-connected via an electric communication line (not illustrated), such as a packet communication network, and the controller 11A stores the distribution information received by the communication interface 7 to the distribution data storage unit 8. The traffic information is, for example, real-time road traffic information required by drivers of the movable bodies 10₁, . . . , 10_{N} such as traffic congestion statuses, congestion statuses, block traveling times, construction control points and traffic accidents or problem statuses of vehicles. The destination guide information is, for example, store information, such as restaurants, hospitals or banks, or sightseeing information on amusement parks and tourist resorts.

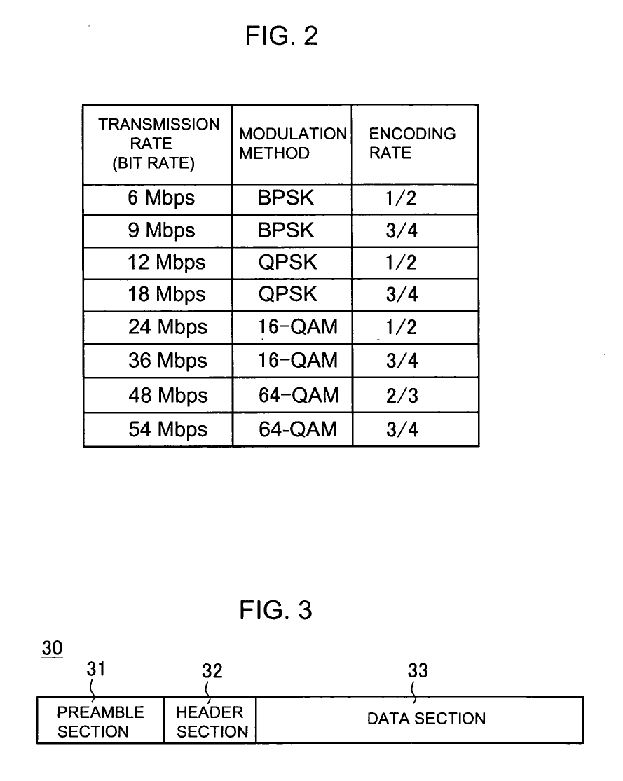

The communication control unit 20 of the controller 11A reads the distribution information from the distribution data storage unit 8, transfers it to the radio transmission unit 9, and controls the radio transmission unit 9 so as to broadcast or multicast the same distribution information at predetermined timings. The radio transmission unit 9 has a function to transmit the data signals at a variable transmission rate by switching the digital modulation method and encoding rate of the data signals to be transmitted without wires. If the radio transmission unit 9 conforms to the IEEE 802.11a standard, the data signals can be transmitted by one of the combinations of the transmission rate (bit rate), modulation method and encoding rate shown in FIG. 2. The encoding rate is defined by the ratio of the bit count of the original data to the bit count after encoding. According to FIG. 2, the radio transmission unit 9 performs digital modulation on the data signals by one of BPSK (Binary Phase Shift Keying), QPSK (Quadrature Phase Shift Keying), 16-QAM (16-Quadrature Amplitude Modulation) and 64-QAM (64-Quadrature Amplitude Modulation), and transmission data can be acquired by sampling the modulation signals acquired by this result at one of the encoding rates ½, 3/4 or ⅔. FIG. 3 is a diagram depicting a general structure of a frame signal according to the IEEE 802.11a standard. According to FIG. 3, the frame signal 30 to be transmitted from the radio transmission unit 9 is comprised of a preamble section 31, header section 32 and data section 33. The header section 32 is transmitted at a fixed transmission rate of 6 Mbps, and the transmission rate of the data section 33 and data length are included in the header section 32. The data section 33 constituting the transmission data is transmitted at a transmission rate specified by the header section 32. Therefore the receivers (stations) ST₁, . . . , ST_{N} can receive the data section 33 by reading the header section 32 of the received frame signal 30.

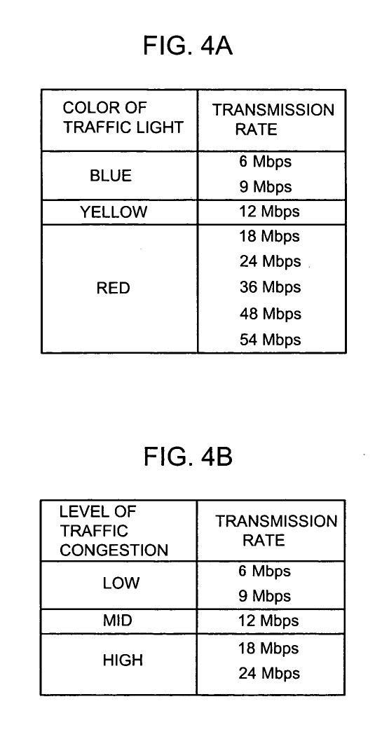

The transmission rate setting unit 21 has a function to change the transmission rate (bit rate) of the data signals to be transmitted without wires according to the later mentioned speed control information and traffic congestion information. The transmission rate setting unit 21 has a predetermined transmission rate table, as shown in FIG. 4, and can change the transmission rate of the data signals referring to this transmission rate table. According to the transmission rate table in FIG. 4A, low speed transmission rate, 6 Mbps or 9 Mbps, is selected when the color of the traffic light 15 (FIG. 1) is blue, mid-transmission rate 12 Mbps is selected when the traffic light color is yellow, and high transmission rate 18 Mbps-45 Mbps is selected when the traffic light color is red. According to the transmission rate table in FIG. 4B, the low transmission rate, 6 Mbps or 9 Mbps, is selected when the level of traffic congestion of the traveling path 17, that is the level of traffic volume of the movable bodies 10₁, . . . , 10_{N} per unit time, is low, the mid-transmission rate 12 Mbps is selected when the level of traffic congestion is medium, and the high transmission rate, 18 Mbps-45 Mbps, is selected when the level of traffic congestion is high.

In the transmission rate table shown in FIG. 4A, three levels of transmission rates corresponding to the respective colors of the traffic light 15, blue, yellow and red respectively are set, but instead a transmission rate table where two levels of transmission rates corresponding to red and another color of the traffic light 15 or two levels of transmission rates corresponding to blue and another color of the traffic light 15 are set, may be used.

The detection unit 22A has a function to detect the speed control information for the movable bodies 10₁, . . . , 10_{N} having the receivers ST₁, . . . , ST_{N} respectively. Specifically, responding to the transmission request from the data distribution device 2A, the traffic control unit 12 transmits information the same as the speed control information to be supplied to the traffic light 15 to the data distribution device 2A via an electric communication line, and the detection unit 22A detects the speed control information received by the communication interface 6, and sends this to the transmission rate setting unit 21. The traffic control unit 12 also has a function to transmit [information] periodically or according to a predetermined time schedule without waiting for the transmission request from the information distribution unit 2A. As described above, the transmission rate setting unit 21 determines the transmission rate of the data signals according to the speed control information.

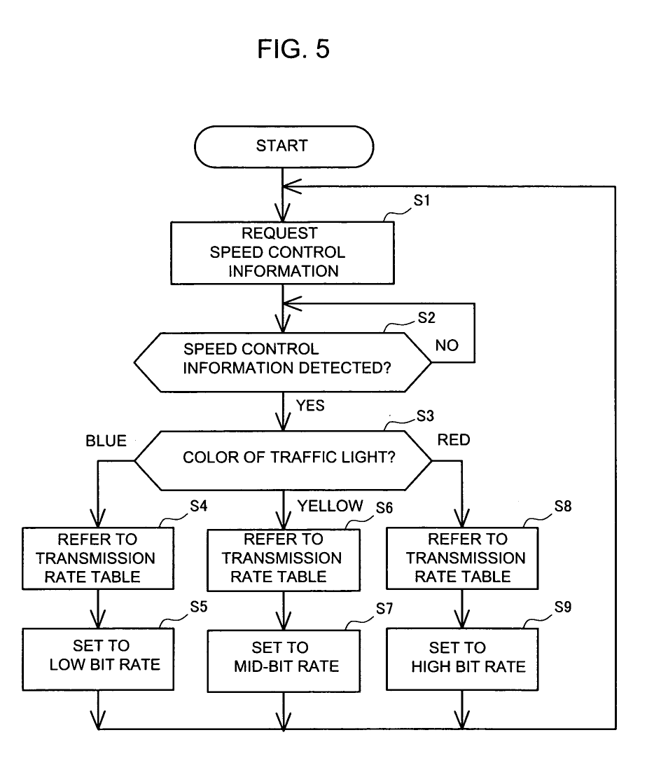

Operations of the information distribution system 1A having the above configuration will be described below. FIG. 5 is a flow chart depicting an example of the processing procedure by the controller 11A of the information description device 2A.

In FIG. 5 the detection unit 22A first requests the speed control information to the traffic control unit 12 according to a predetermined time schedule (step S1). Then the detection unit 22A judges whether the speed control information transmitted from the traffic control unit 12 was detected (step S2). After transmitting the transmission request to the traffic control unit 12 (step S1), the detection unit 22A stands by until the speed control information transmitted from the traffic control unit 12 is detected. When the speed control information cannot be detected, even if a predetermined time has elapsed, the detection unit 22A may repeatedly request the speed control information to the traffic control unit 12.

When the traffic control unit 12 transmits the speed control information responding to the transmission request and the detection unit 22A detects the speed control information received by the communication interface 6, the detection unit 22A sends the speed control information to the transmission rate setting unit 21, and the transmission rate setting unit 21 sets the transmission rate according to the speed control information referring to the transmission rate table, and stores this in a register of the communication control unit 20 (steps S4-S7B). In other words, the speed control information includes the information on the colors of the traffic light 15, the transmission rate setting unit 21 judges whether the color of the traffic light 15 is blue, yellow or red (step S4), refers to the transmission rate table shown in FIG. 4A (steps S4, S6, S8), and sets the transmission rate of the data signals to the bit rate according to the determined traffic light color (steps S5, S7, S9). If the color of the traffic light 15 is blue, the transmission rate setting unit 21 judges that the movable bodies 10₁, . . . , 10_{N} are moving at a relatively high speed, and sets the transmission rate to the low bit rate (6 Mbps or 9 Mbps). If the traffic light color is yellow, the transmission rate setting unit 21 judges that the movable bodies 10₁, . . . , 10_{N} are moving at a relatively slow speed, and sets the transmission rate to the mid-bit rate (12 Mbps). If the traffic light color is red, the transmission rate setting unit 21 judges that the movable bodies 10₁, . . . , 10_{N} are stopping, and sets the transmission rate to a high bit rate (one of 18 Mbps-54 Mbps).

After the transmission rate is set in steps S5, S7 and S9, the processing after step S1 is repeatedly executed. The communication control unit 20 controls the radio transmission unit 9 so as to transmit the data signals at the transmission rate stored in a register. If the transmission rate stored in a register is updated, the communication control unit 20 controls the radio transmission unit 9 so as to transmit the data signals at a new transmission rate. The radio transmission unit 9 performs digital modulation on the distribution information stored in the distribution data storage unit 8 according to a specified modulation method, and multicasts or broadcasts it at a specified encoding rate.

As described above, the information distribution system 1A enables high quality data distribution without dropping the throughput of a wireless LAN, since data is transmitted at a transmission rate appropriate for the traveling speed of the movable bodies 10₁, . . . , 10_{N} based on the speed control information supplied from the traffic control unit 12. Real-time transmission rate control is also possible by a relatively simple algorithm. Therefore even in a relatively narrow communication area of a wireless LAN, highly reliable information distribution is possible.

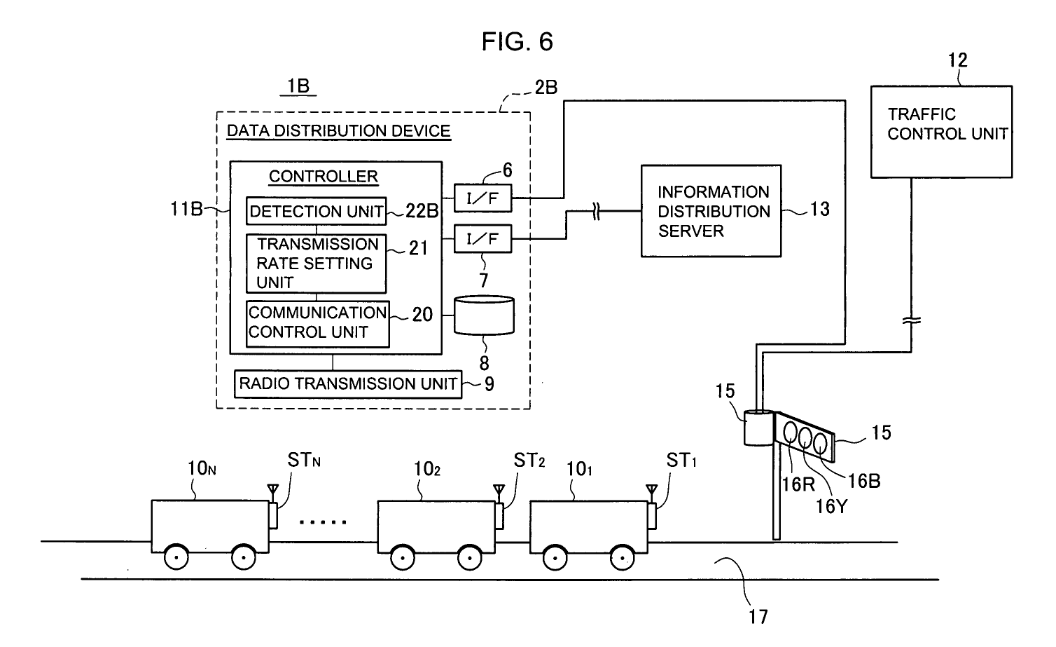

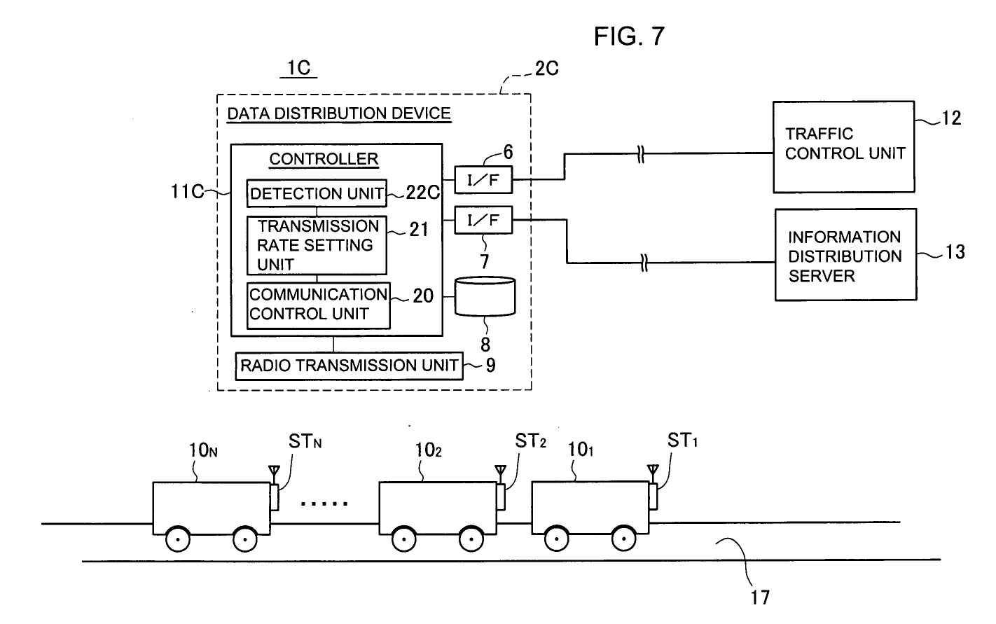

Now a variant form of the information distribution system 1A will be described. FIG. 6 and FIG. 7 are block diagrams depicting a general configuration of the information distribution systems 1B and 1C according to the first and second variant forms respectively. In each variant form, a composing element denoted with a same reference numeral as a composing element of the information distribution system 1A has a same function as this composing element, therefore detailed description is omitted.

In the information distribution system 1B of the first variant form (FIG. 6), speed control information to the data distribution device 2B is not supplied from the traffic control unit 12, but from the control box 18 of the traffic light 15. The detection unit 22B of the controller 11B detects the speed control information received by the communication interface 6, and sends it to the transmission rate setting unit 21. The control box 18 of the traffic light 15 and the communication interface 6 may be inter-connected via a cable, or the control box 18 and the communication interface 6 may be inter-connected via a communication line using Internet technology by linking an IP address (Internet Protocol address) conforming to IPv4 (Internet Protocol version 4) or IPv6 (Internet Protocol version 6) to the control box 18.

In the present embodiment, the data distribution device 2B does not receive speed control information from a remote traffic control unit 12 via an electric communication line, but receives speed control information from a traffic light 15 at a control point, so the detection unit 22B can acquire information on an ON and OFF of the traffic light 15 with more certainty. For example, even when the traffic light 15 autonomously operates without being controlled by the traffic control unit 12, the transmission rate can be changed according to the traveling speed of the movable bodies 10₁, . . . , 10_{N}. And even if an abnormality occurs to the electric communication line between the traffic control unit 12 and the data distribution device 2B, the transmission rate can be controlled regardless the abnormality.

In the case of the information distribution system 1C of the second variant form (FIG. 7), the data distribution device 2C receives traffic congestion information instead of speed control information from the traffic control unit 12 via an electric communication line, and the detection unit 22C of the controller 11C detects the traffic congestion information received by the communication interface 6, and sends this to the transmission rate setting unit 21. The transmission rate setting unit 21 sets a transmission rate according to the traffic congestion information referring to the transmission rate table shown in FIG. 4B, and stores this in a register of the communication control unit 20. The transmission rate setting unit 21 sets the transmission rate to the high bit rate if the level of traffic congestion is high, assuming that the movable bodies 10₁, . . . , 10_{N} are moving at low speed or are stopping, sets the transmission rate to the mid-bit rate if the level of traffic congestion is medium, assuming that the movable bodies 10₁, . . . , 10_{N} are moving at mid-speed, and sets the transmission rate to the low bit rate if the level of traffic congestion is low, assuming that the movable bodies 10₁ . . . , 10_{N} are moving at a relatively high speed. As a result, the radio transmission unit 9 transmits the data signals at a transmission rate according to the traffic congestion status of the traveling path 17. The traffic control unit 12 is, for example, a known VICS (Vehicle Information and Communication System).

### 2. Second Embodiment

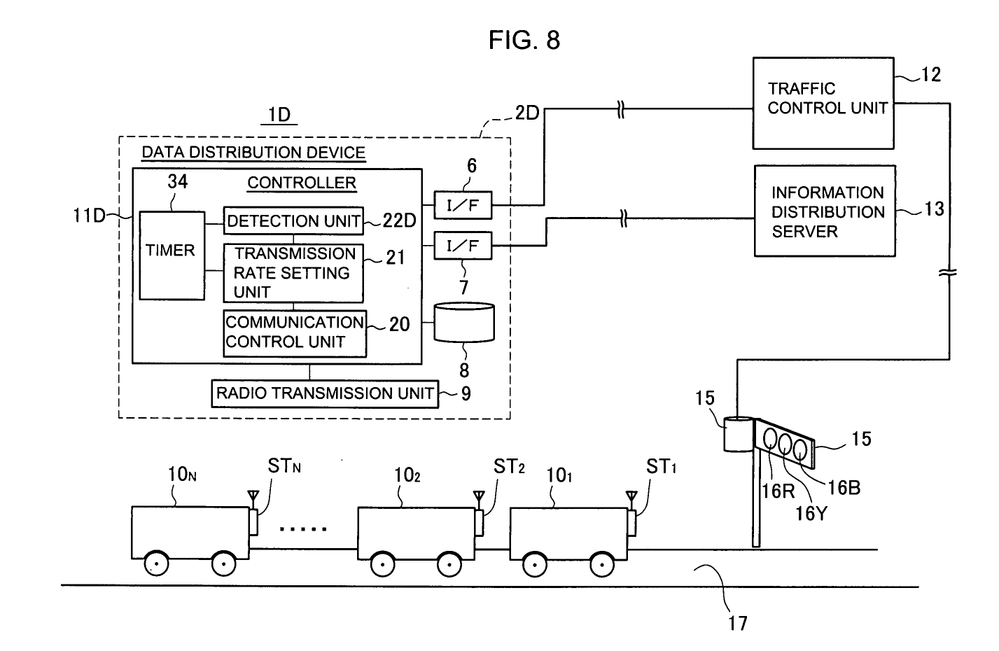

Now the second embodiment according to the present invention will be described. FIG. 8 is a block diagram depicting a general configuration of the information distribution system 1D according to the second embodiment. In FIG. 8, a composing element denoted with a same reference numeral as a composing element of the information distribution system 1A has a same function as this composing element, therefore detailed description is omitted.

The information distribution system 1D comprises a data distribution device 2D, a traffic control unit 12 and an information distribution server 13. The data distribution device 2D further comprises a controller 1D, a radio transmission unit 9, communication interfaces 6 and 7 and a distribution data storage unit 8, and the controller 11D further comprises a communication control unit 20, a transmission rate setting unit 21, and a detection unit 22D and timer 34. The controller 11D is an integrated circuit comprising a microprocessor, a non-volatile memory for storing programs, a RAM, an internal bus and an input/output interface, just like the controller 11A of the first embodiment.

The transmission rate setting unit 21 has a function to change the transmission rate (bit rate) of the data signals to be transmitted without wires according to the speed control information and traffic congestion information, just like the transmission rate setting unit 21 of the first embodiment, and can change the transmission rate of the data signals referring to the transmission rate table shown in FIG. 4.

The detection unit 22D has a function to detect the speed control information for the movable bodies 10₁, . . , 10_{N} having the receivers ST₁, . . . , ST_{N} respectively, just like the detection unit 22A of the first embodiment. In the present embodiment, the timer 34 can measure the start time and end time of the speed control for the movable bodies 10₁ , . . . , 10_{N} based on the speed control information. The detection unit 22D has a function to acquire the time schedule of executing speed control for the movable bodies 10₁, . . . , 10_{N} using the timer 34, and storing this.

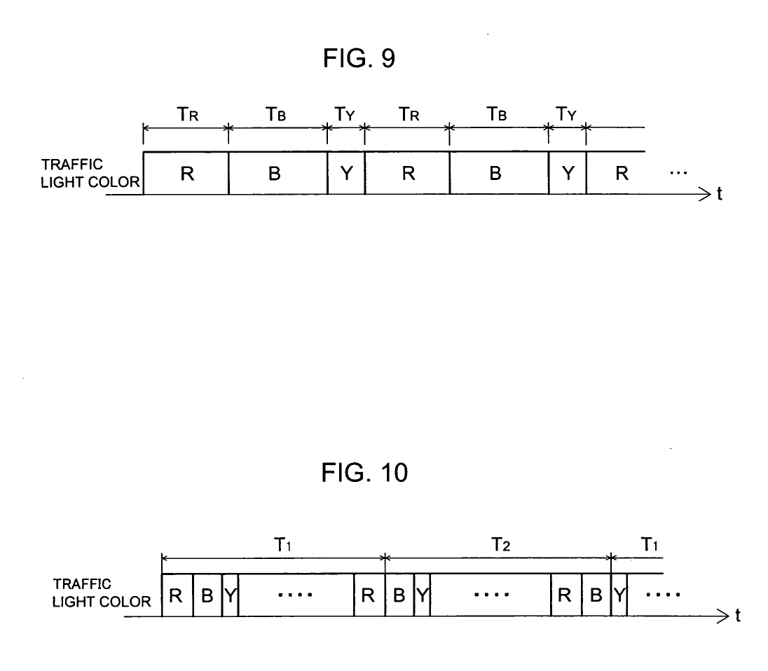

As the timing chart in FIG. 9 shows, the color of the traffic light 15 periodically changes in the sequence of R (red), B (blue), Y (yellow), R, B, Y, . . . according to the speed control information. The red light ON period T_{R}, blue light ON period T_{B} and yellow light ON period T_{Y} could change according to the traffic congestion status of the traveling path 17, the time zone and the day of the week, but normally the light ON periods T_{R}, T_{B} and T_{Y} are not changed over a short time period, such as ten and several seconds. The detection unit 22D acquires the time schedule by measuring the light ON periods T_{R}, T_{B} and T_{Y} using the timer 34 in the first period (measurement period) T₁, and stores this. In the second period (autonomous period) T₂ subsequent to the measurement period T₁, the detection unit 22D itself generates the speed control information according to the stored time schedule without depending on the speed control information supplied from the outside, and sends this to the transmission rate setting unit 21. Therefore in the autonomous period T₂, the transmission rate setting unit 21 sets the transmission rate according to the above mentioned time schedule. As FIG. 10 shows, the measurement period T₁ and the autonomous period T₂ appear periodically.

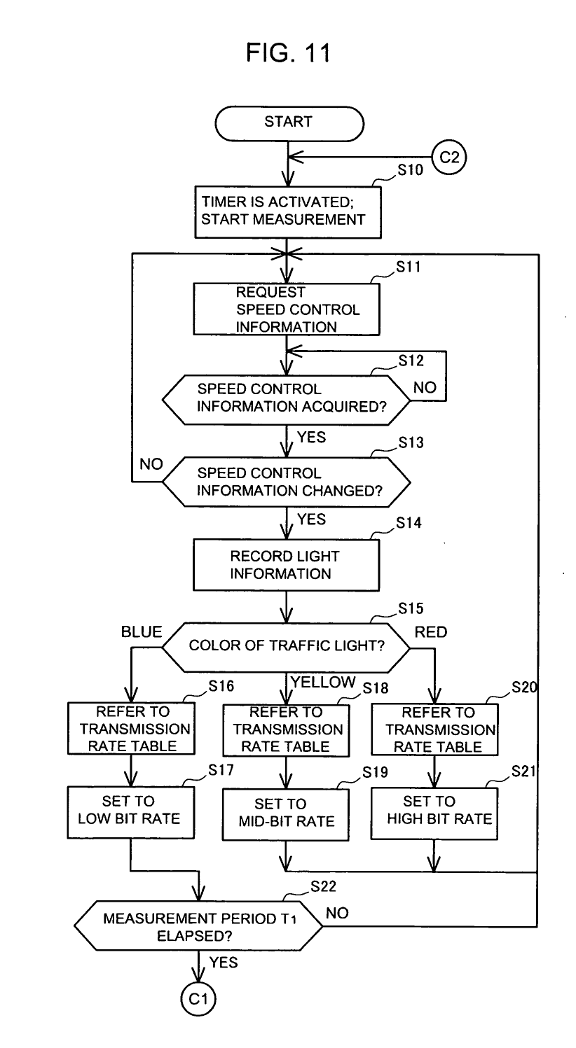

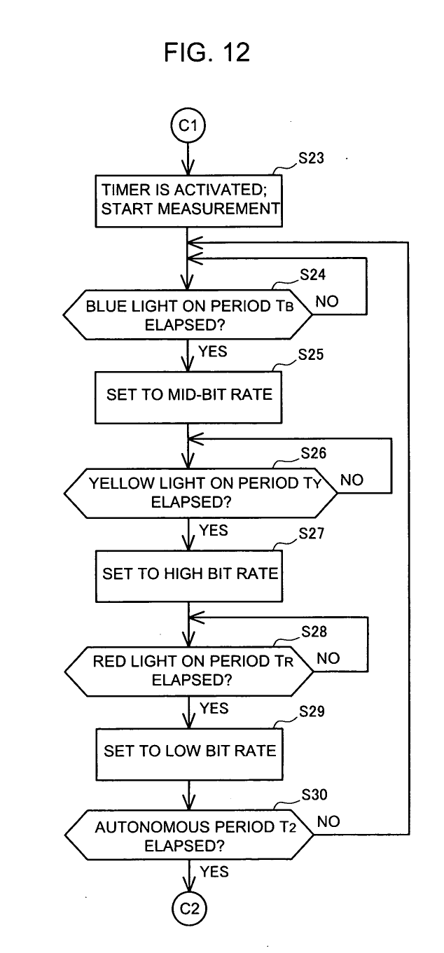

Now the operation of the information distribution system 1D having the above configuration will be described. FIG. 11 and FIG. 12 are flow charts depicting an example of the processing procedure by the controller 11D of the data distribution device 2D. The flow chart in FIG. 11 and the flow chart in FIG. 12 are continuous via the connectors C1 and C2.

According to FIG. 11, the timer 34 is started by the detection unit 22D, and the measurement of elapsed time in measurement period T₁ is started (step S10). Then the detection unit 22D requests speed control information to the traffic control unit 12 (step S11). Then the detection unit 22D judges whether the speed control information transmitted from the traffic control unit 12 was detected (step S12). The detection unit 22D transmits a transmission request to the traffic control unit 12 (step S11), and then stands by until the speed control information transmitted from the traffic control unit 12 is detected. When the speed control information is not detected even if a predetermined time elapses, the detection unit 22D may repeatedly request speed control information to the traffic control unit 12.

When the traffic control unit 12 transmits the speed control information responding to the transmission request, and the detection unit 22D detects the speed control information received by the communication interface 6, the detection unit 22D judges whether the speed control information has changed or not, that is whether the speed control information previously received is different from that received this time (step S13). For example, if the previous color of the traffic light 15 is red and the traffic light color at this time is also red, then the detection unit 22D returns the processing back to step S11 judging that the speed control information is unchanged. If the color of the traffic light 15 changed from red to blue, on the other hand, the detection unit 22D moves the processing to the next step, S14, judging that the speed control information changed. If the speed control information changes, the detection unit 22D records the light information in the internal memory (step S14). Specifically, if the color of the traffic light 15 changes from red to blue, the red light ON period T_{R} and the information that the traffic light color changed from red to blue are recorded.

Then the transmission rate setting unit 21 judges whether the color of the traffic light 15 is blue, yellow or red (step S15), refers to the transmission rate table shown in FIG. 4A (steps S16, S18, S20), and sets the transmission rate of the data signals to the bit rate according to the judged traffic light color (steps S17, S19, S21). If the traffic light color is yellow or red, the transmission rate is set to the mid-bit rate or the high bit rate (steps S19, S21), then the processing after step S11 is repeatedly executed. If the traffic light color is blue, on the other hand, the transmission rate setting unit 21 sets the transmission rate to the low bit rate (step S17), then judges whether measurement period T₁ has elapsed based on the time data supplied from the timer 34 (step S22), and returns processing back to step S11 if it is judged that measurement period T₁ has not elapsed. If it is judged that measurement period T₁ has elapsed in step S22, on the other hand, the detection unit 22D moves processing to step S23 and later, as shown in FIG. 12.

According to FIG. 12, in step S23, the timer 34 is started by the detection unit 22D, and measurement of elapsed time in autonomous period T₂ is started (step S23). Then the detection unit 22D judges whether the blue light ON period T_{B} has elapsed, and stands by until the blue light ON period T_{B} elapses (step S24). When the blue light ON period T_{B} elapses, the color of the traffic light 15 changes from blue to yellow. In the next step, S25, the detection unit 22D reads the time schedule recorded in measurement period T₁, generates the speed control information that the traffic light color is yellow, and sends this to the transmission rate setting unit 21. The transmission rate setting unit 21 refers to the transmission rate table shown in FIG. 4A, and sets the transmission rate to the mid-bit rate.

Then the detection unit 22D judges whether the yellow light ON period T_{Y} has elapsed, and stands by until the yellow light ON period T_{Y} elapses (step S26). When the yellow light ON period T_{Y} elapses, the color of the traffic light 15 changes from yellow to red. In the next step, S27, the detection unit 22D reads the above mentioned time schedule, generates the speed control information that the traffic light color is red, and sends this to the transmission rate setting unit 21. The transmission rate setting unit 21 refers to the transmission rate table shown in FIG. 4A, and sets the transmission rate to the high bit rate.

Then the detection unit 22D judges whether the red light ON period T_{R} has elapsed, and stands by until the red light ON period T_{R} elapses (step S28). When the red light ON period T_{R} elapses, the color of the traffic light 15 changes from red to blue. In the next step, S29, the detection unit 22D reads the above mentioned time schedule, generates the speed control information that the traffic light color is blue, and sends this to the transmission rate setting unit 21. The transmission rate setting unit 21 refers to the transmission rate table shown in FIG. 4A, and sets the transmission rate to the low bit rate. Then the detection unit 22D judges whether autonomous period T₂ has elapsed based on the time data supplied from the timer 34 (step S30). If the detection unit 22D judged that autonomous period T₂ has not elapsed, the processing after step S24 is repeatedly executed, and if the detection unit 22D judged that autonomous period T₂ has elapsed, the processing in measurement period T₁ in step S10 and later is repeatedly executed.

As described above, the information distribution system 1D enables high quality data distribution without dropping the throughput of the wireless LAN, just like the information distribution system 1A of the first embodiment. Real-time transmission rate control is also possible by a relatively simple algorithm. Also in the case of the present embodiment, the number of times of transmitting speed control information transmission requests to the traffic control unit 12 decreases, so the processing load on the traffic control unit 12 can be decreased.

### 3. Third Embodiment

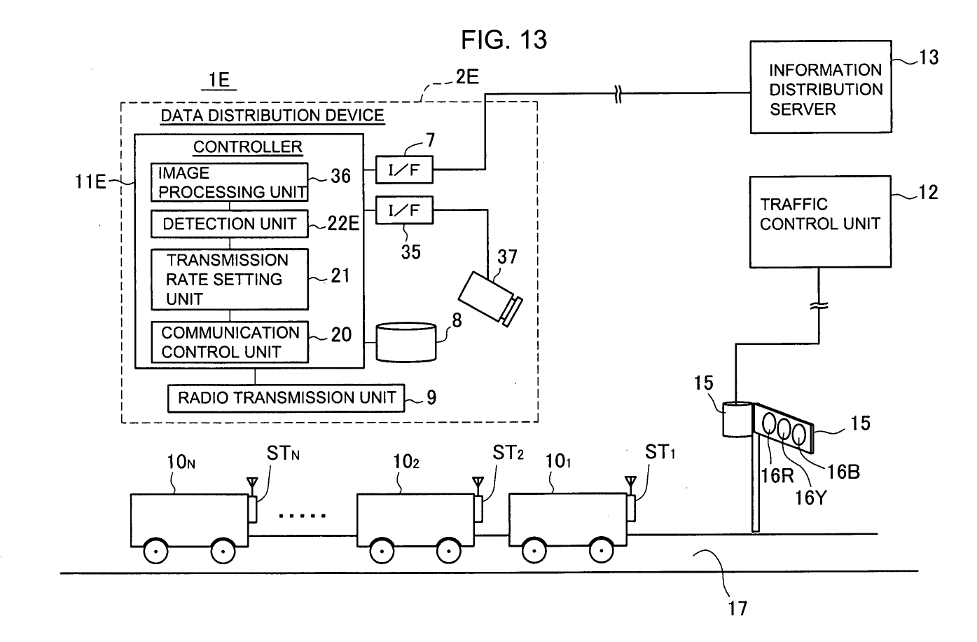

The third embodiment according to the present invention will now be described. FIG. 13 is a block diagram depicting a general configuration of the information distribution system 1E according to the third embodiment. In FIG. 13 a composing element denoted with a same reference numeral as a composing element of the information distribution system 1A has a same function as this composing element, therefore detailed description is omitted.

The information distribution system 1E comprises a data distribution device 2E and an information distribution server 13. The data distribution device 2E further comprises a controller 11E, a distribution data storage unit 8, a radio transmission unit 9, a communication interface 7, an imaging device (image pickup device) 37 and an input interface 35, and the controller 11E further comprises a communication control unit 20, a transmission rate setting unit 21, a detection unit 22E and an image processing unit 36. The controller 11E is an integrated circuit comprising a microprocessor, a non-volatile memory for storing programs, a RAM, an internal bus and an input/output interface, just like the controller 11A of the first embodiment.

The imaging device 37 further comprises a solid-state image sensing device comprised of a CCD sensor and CMOS sensor, and an optical system and signal processing system, and is positioned in an area near the control point where the speed control for the movable bodies 10₁, . . . , 10_{N} is performed, and has a visual field which allows capturing an image of the area near the control point. In the present embodiment, the imaging device 37 captures images of the red light source 16R, blue light source 16B and yellow light source 16Y of the traffic light 15, generates moving image signals, and outputs them to the input interface 35. The input interface 35 removes noise from the moving image signals, adjusts the gain of the moving image signals to an optimum level, and supplies the moving image signals to the image processing unit 36 after A/D conversion. The image processing unit 36 performs image processing on the moving image data to be input from the input interface 35, then sends [the processed data] to the detection unit 22E.

The detection unit 22E has a function to detect the speed control information based on the image data captured by the imaging device 37. Specifically, the image processing unit 36 converts each image frame into plane sequential data comprised of R frames having only red components, Y frames having only yellow components and B frames having only blue components, calculates the average luminance of the R frames, Y frames and B frames respectively, and supplies these to the detection unit 22E. The detection unit 22E judges whether each average luminance is a predetermined threshold or less, so as to detect the ON or OFF of the red light source 16R, yellow light source 16Y and blue light source 16B respectively, generates the speed control information, and sends it to the transmission rate setting unit 21. Another analysis processing that may be used is that image data including only the image area of the red light source 16R, image data including only the image area of the yellow light source 16Y and image data including only the image area of the blue light source 16B are extracted, and the average luminance of each image data is calculated.

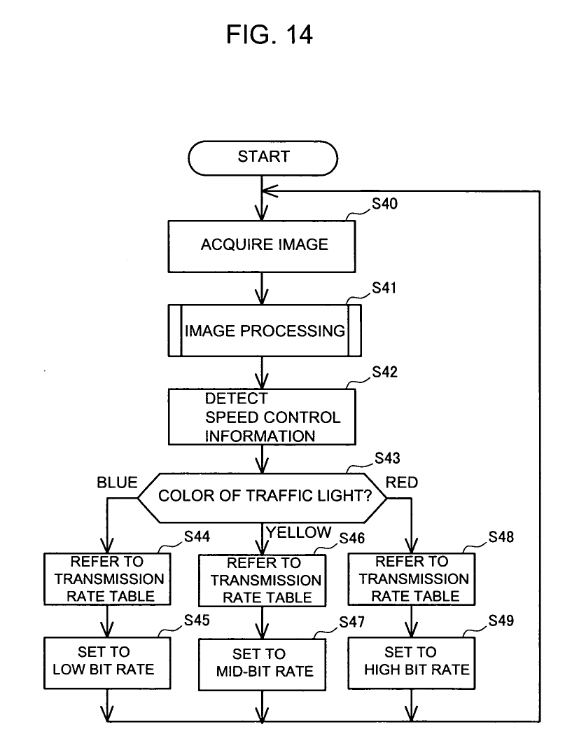

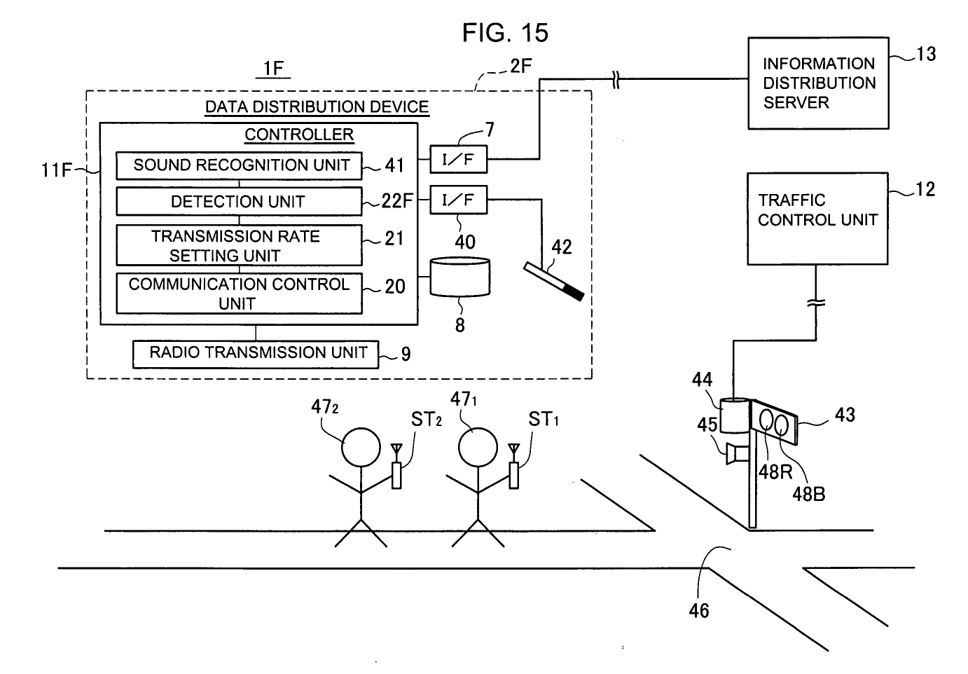

Operation of the information distribution system 1E having the above configuration will now be described. FIG. 14 is a flow chart depicting an example of the processing procedure by the controller 11E of the data distribution device 2E.

According to FIG. 14, the image processing unit 36 samples the moving image data supplied from the input interface 35, and acquires this (step S40). Then the image processing unit 36 processes the moving image data (step S41), the detection unit 22E detects the speed control information based on the processing data which is input from the image processing unit 36, and sends this to the transmission rate setting unit 21 (step S42).

The transmission rate setting unit 21 judges whether the color of the traffic light 15 is blue, yellow or red (step S43), refers to the transmission rate table shown in FIG. 4A (steps S44, S46, S48), and sets the transmission rate of the data signal to the bit rate according to the judged traffic light color (steps S45, S47, S49). If the traffic light color is blue, the transmission rate is set to the low bit rate (step S45), if the traffic light color is yellow, the transmission rate is set to the mid-bit rate (step S47), and if the traffic light color is red, the transmission rate is set to the high bit rate (step S49). Then the processing after step S40 is repeatedly-executed.

As described above, the information distribution system 1E of the present embodiment enables high quality data distribution without dropping the throughput of the wireless LAN, since data is transmitted at a transmission rate appropriate for the traveling speed of the movable bodies 10₁, . . . , 10_{N} based on the moving images captured by the imaging device 37. Real-time transmission rate control is also possible by a relatively simple algorithm. Compared with the first and second embodiments, it is unnecessary to acquire speed control information from the outside via an electric communication line or cable, so stable transmission rate control is possible.

### 4. Fourth Embodiment

The fourth embodiment according to the present invention will now be described. FIG. 15 is a block diagram depicting a general configuration of the information distribution system 1F according to the fourth embodiment. In FIG. 15, a composing element denoted with a same composing element as the information distribution system 1A has a same function as this composing element, therefore detailed description is omitted.

The information distribution system 1F comprises a data distribution device 2F and an information distribution server 13. The data distribution device 2F comprises a controller 11F, a distribution data storage unit 8, a radio transmission unit 9, a communication interface 6, a directional microphone 42 and an input interface 40, and the controller 11F further comprises a communication control unit 20, a transmission rate setting unit 21, a detection unit 22F and a sound recognition unit 41. The controller 11F is an integrated circuit comprising a microprocessor, a non-volatile memory for storing programs, a RAM, an internal bus and an input/output interface, just like the controller 11A of the first embodiment.

The traffic control unit 12 generates the speed control information according to a predetermined time schedule, supplies this to the traffic light 43, and remote-controls the traffic light 43. The traffic light 43 comprises a red light source 48R, blue light source 48B and a speaker 45, and is positioned in the vicinity of an intersection (control point) 46. The traffic light 43 has a control box 44, and the control box 44 controls the ON/OFF of the red light source 48R and the blue light source 48B respectively based on the speed control information supplied from the traffic control unit 12. The control box 44 and the traffic control unit 12 are inter-connected via an electric communication line (not illustrated), such as a packet communication network. ON of the red light source 48R indicates “Stop”, and ON of the blue light source 48B indicates “Go”. The control box 44 also controls the speaker 45 so as to transmit control sound to the pedestrians 47₁ and 47₂ according to the ON and OFF of the red light source 48R and the blue light source 48B. For example, when the red light source 48R is ON, the speaker 45 transmits an alarm sound, and when the blue light source 48B is ON, the speaker 45 transmits a guiding sound.

The directional microphone 42 is positioned near the control point where the speed control for the movable bodies (pedestrians) 47₁ and 47₂ is performed, and detects sounds in the area near the control point. The input interface 40 removes noise from the sound signals which are input from the directional microphone 42, and A/D converts the sound signals and then outputs the converted sound signals to the sound recognition unit 41. The sound recognition unit 41 extracts the characteristics of the cepstrum area of the sound data which is input from the input interface 40, and outputs it to the detection unit 22F. The detection unit 22F detects the speed control information by comparing the sound patterns which are provided in advance, and this characteristic quantity.

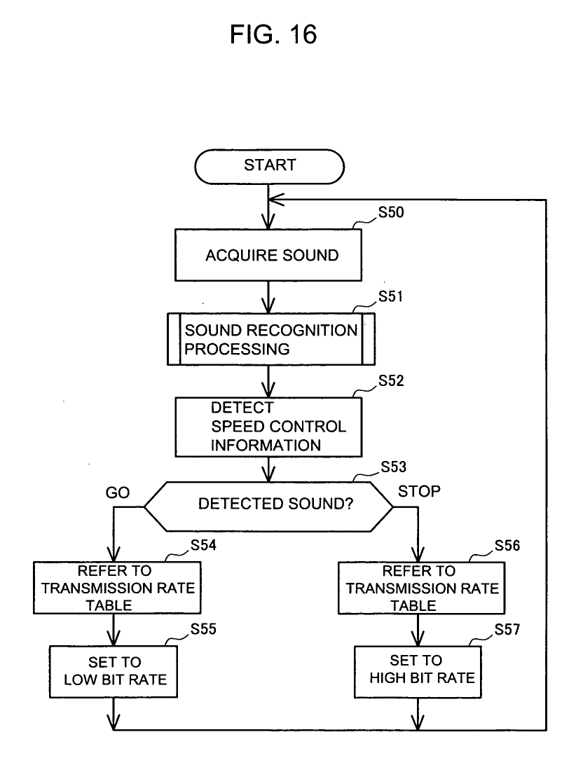

Operation of the information distribution system 1F having the above configuration will now be described below. FIG. 16 is a flow chart depicting an example of the processing procedure by the controller 11F of the data distribution device 2F.

According to FIG. 16, the sound recognition unit 41 samples and acquires the sound data supplied from the input interface 40 (step S50). Then the sound recognition unit 41 calculates the characteristic quantity by performing sound recognition processing on the sound data, and outputs this to the detection unit 22F (step S51). The detection unit 22F detects the speed control information based on the characteristic quantity which is input from the sound recognition unit 41 (the characteristic quantity is hereinafter the “detected sound”), and supplies this to the transmission rate setting unit 21 (step S52).

The transmission rate setting unit 21 judges whether the detected sound is a sound indicating either “Go” or “Stop” (step S53), refers to the transmission rate table (steps S54, S56), and sets the transmission rate of the data signals to a bit rate according to the judged sound (steps S55, S57). If the detected sound indicates “Go”, the transmission rate is set to the low bit rate (step S55), and if the detected sound indicates “warning”, the transmission rate is set to the high bit rate (step S57). Then the processing after step S50 is repeatedly executed.

As described above, the information distribution system 1F of the present embodiment enables high quality data distribution without dropping the throughput of the wireless LAN, since the data is transmitted at a transmission rate appropriate for the moving speed of the pedestrians 471 and 472 based on the sounds detected by the directional microphones 42.

It is understood that the foregoing description and accompanying drawings set forth the preferred embodiments of the invention at the present time. Various modification, additions and alternatives will, of course, become apparent to those skilled in the art in light of the foregoing teachings without departing from the spirit and scope of the disclosed invention. Thus it should be appreciated that the invention is not limited to the disclosed embodiments, but may be practiced within the full scope of the appended Claims.

This application is based on Japanese Patent Application No. 2004-122697, which is hereby incorporated by reference.

1. An information distribution system comprising:
a radio transmission unit for transmitting data signals at a transmission rate being variable;
a detection unit for detecting speed control information for a mobile object having a receiver for receiving data signals transmitted without wires from said radio transmission unit; and
a transmission rate setting unit for changing the transmission rate of the data signals according to said speed control information.

2. An information distribution system according to claim 1, wherein said detection unit receives said speed control information supplied from a traffic control unit which remote-controls traffic control means for controlling a speed of said mobile object.

3. An information distribution system according to claim 1, wherein said detection unit receives said speed control information supplied from traffic control means for controlling a speed of said mobile object.

4. An information distribution system according to claim 1, further comprising a timer for measuring start time and end time of speed control for said mobile object based on said speed control information, wherein said detection unit acquires a time schedule of controlling a speed of said mobile object using said timer and stores the time schedule, and said transmission rate setting unit changes the transmission rate of said data signals according to said time schedule.

5. An information distribution system according to claim 4, wherein said detection unit acquires said time schedule in each predetermined period of time.

6. An information distribution system according to claim 1, further comprising an imaging device positioned near a control point where a speed of said mobile object is to be controlled and capturing an image of an area including said control point, wherein said detection unit detects said speed control information based on moving image data taken by said imaging device.

7. An information distribution system according to claim 1, further comprising a microphone positioned near a control point where a speed of said mobile object is to be controlled and detecting sound in an area near said control point, wherein said detection unit extracts characteristics of the sound detected by said microphone and detects said speed control information based on said characteristics.

8. An information distribution system according to claim 1, wherein said transmission rate setting unit includes a transmission rate table in which a transmission rate corresponding to said speed control information is stored, and the transmission rate of said data signals is changed by referring to said transmission rate table.

9. An information distribution system according to claim 1, wherein said radio transmission unit is positioned near a control point where a speed of said mobile object is to be controlled.

10. An information distribution system according to claim 1, wherein said transmission rate setting unit changes said transmission rate by changing a modulation method and an encoding rate of data signals to be transmitted without wires.

11. An information distribution system according to claim 1, wherein said detection unit detects information indicating timing of turning ON or OFF of a traffic light positioned in the vicinity of a traveling path of said mobile object as said speed control information.

12. An information distribution system according to claim 1, wherein said radio transmission unit broadcasts said data signals.

13. An information distribution system according to claim 1, wherein said radio transmission unit multicasts said data signals.

14. An information distribution system according to claim 1, further comprising an information distribution source for supplying at least one information item selected from traffic information around a control point where a speed of said mobile object is to be controlled, destination guide information, advertisement information, and news information as said distribution information.

15. An information distribution system according to claim 1, wherein said radio transmission unit conforms to a wireless LAN standard.

16. An information distribution system comprising:
a radio transmission unit for transmitting data signals at a transmission rate being variable;
a detection unit for detecting traffic congestion information for a mobile object having a receiver for receiving data signals transmitted without wires from said radio transmission unit; and
a transmission rate setting unit for setting a transmission rate of said data signals according to said traffic congestion information.

17. An information distribution system according to claim 16, wherein said transmission rate setting unit comprises a transmission rate table in which the transmission rate corresponding to said traffic congestion information is stored, and the transmission rate of said data signals is changed by referring to said transmission rate table.

18. An information distribution system according to claim 16, wherein said transmission rate setting unit changes said transmission rate by changing a modulation method and an encoding rate of data signals to be transmitted without wires.

19. An information distribution system according to claim 16, wherein said detection unit detects information indicating timing of turning ON or OFF of a traffic light positioned in the vicinity of a traveling path of said mobile object as said speed control information.

20. An information distribution system according to claim 16, wherein said radio transmission unit broadcasts said data signals.

21. An information distribution system according to claim 16, wherein said radio transmission unit multicasts said data signals.

22. An information distribution system according to claim 16, further comprising an information distribution source for supplying at least one information item selected from the traffic information around a control point where a speed of said mobile object is to be controlled, destination guide information, advertisement information and news information as said distribution information.

23. An information distribution system according to claim 16, wherein said radio transmission unit conforms to a wireless LAN standard.
